(19) United States
(12) Patent Application Publication
(10) Pub. No.: US 2025/0296121 A1
(43) Pub. Date: Sep. 25, 2025

(54) Cleaning device

(71) Applicant: Andreas Stihl AG & Co. KG, Waiblingen (DE)

(72) Inventor: Alexander Kiebler, Kirchberg an der Murr (DE)

(73) Assignee: Andreas Stihl AG & Co. KG, Waiblingen (DE)

(21) Appl. No.: 19/087,654

(22) Filed: Mar. 24, 2025

(30) Foreign Application Priority Data
Mar. 25, 2024 (DE) 102024108427.8

(51) Int. Cl. B08B 3/02

(52) U.S. Cl. CPC B08B 3/026; B08B 2203/027

(57) ABSTRACT

A portable cleaning device for pressurizing and spraying out a liquid includes a pump having several pistons. A piston chamber is allocated to each of the several pistons. The liquid can be pressurized in the piston chamber by the piston. An inlet valve is allocated to each piston chamber. The cleaning device includes a connection device for connecting a source line for supplying liquid. A liquid distribution device for supplying the liquid from the connection device to the several inlet valves is arranged between the connection device and the pump. The liquid distribution device is designed such that it supplies the liquid to the several inlet valves independent of the orientation of the cleaning device, in particular the pump, in relation to the direction of gravity in a fixed predetermined sequence.

### CROSS-REFERENCE TO RELATED APPLICATION

This application claims the benefit of German Patent Application DE 102024108427.8, filed on Mar. 25, 2024, the content of which is incorporated in its entirety.

### BACKGROUND

The disclosure relates to a cleaning device pressurizing and spraying out a liquid. Suction problems can occur with such cleaning devices whose pumps comprise several, i.e. two or more, pistons. In particular, when the liquid is sucked in from a container or a body of water via a hose, it can happen that some of the inlet valves of the several pistons are supplied with air instead of liquid over a longer period of time. The allocated pump chamber then draws air instead of liquid, while other pump chambers are already supplied with liquid. This creates air bubbles in the pressure line, which is located downstream of the pump. These air bubbles can lead to unwanted operating errors. For example, this results in an undefined pressure in the pressure line. Components that switch depending on the pressure, such as a pressure cut-off valve for the pump drive, for example, then switch in an undefined and unreliable manner.

### SUMMARY

The present disclosure improves a cleaning device in such a way that the formation of bubbles in the pressure line of the cleaning device is minimal. This is achieved by the cleaning device as described and claimed.

A liquid distribution device is designed in such a way that it supplies the liquid in several inlet valves in a fixed predetermined sequence, irrespective of the orientation of the cleaning device relative to the direction of gravity. It has been shown that this can significantly reduce the formation of bubbles in the region downstream of the pump.

In particular, the liquid distribution device is designed so that the liquid is fed to the multiple inlet valves in a fixed predetermined sequence, regardless of the orientation of the pump relative to the direction of gravity.

In particular, the cleaning device is portable. It can also be provided that the cleaning device can be guided by hand during operation, in particular that it can be guided by hand together with the pump as a unit.

The liquid distribution device is advantageously designed in such a way that it supplies the liquid to the several inlet valves one after the other in a fixed predetermined sequence, regardless of the orientation of the cleaning device relative to the direction of gravity. As a result, the liquid is fed to one inlet valve after the other. It is impossible for two inlet valves to receive liquid for the first time at the same time. The liquid must first pass through a first inlet valve in order to reach a second inlet valve.

Expediently, the liquid distribution device comprises a channel. The channel has a beginning and an end. A first inlet valve of the several inlet valves is arranged at the beginning of the channel. A last inlet valve of the several inlet valves is arranged at the end of the channel. In particular, the channel is designed in such a way that the liquid can only flow along one path from the beginning to the end of the channel.

The cleaning device can also be set down on a horizontal plane in a set-down orientation provided for this purpose. Advantageously, the channel is designed in such a way that the first inlet valve has the greatest distance of all several inlet valves from the horizontal plane in the set-down orientation. This means that the first inlet valve is arranged at the highest point. Since the first inlet valve is the first to be supplied with liquid, it is ensured that the liquid flows to the other inlet valves located downstream of the first inlet valve with respect to the direction of flow of the liquid under the effect of gravity. As a result, the liquid flows particularly quickly from the first to the second inlet valve. As a result, the time in which only the first inlet valve is supplied with liquid is very short. Thus, the formation of bubbles in the pressure line of the cleaning device is very minimal.

In an advantageous development, it is provided that the channel is designed in such a way that the last inlet valve in the set-down orientation has the smallest distance of all several inlet valves to the horizontal plane. This means that the last inlet valve is arranged at the lowest point. Thus, the inlet valves can be arranged in such a way that, at least in the set-down orientation, the liquid flows from the first valve to all other valves of the several inlet valves under the effect of gravity. Thus, all inlet valves of the several inlet valves are subjected to a particularly fast flow.

In particular, a reservoir is formed at the beginning of the channel. Advantageously, the channel is formed in such a way that, in the set-down orientation, only the first inlet valve can be supplied with liquid from the channel as long as the reservoir has not overflowed and supplies the portion of the channel downstream of the reservoir with liquid due overflowing the reservoir. Thus, the force of gravity when the liquid flows from the first valve to the downstream valves is utilized. This results in a particularly fast flow to the downstream valves. As a result, the time in which only the first inlet valve is supplied with liquid is short.

The several inlet valves each have an inlet opening facing towards the channel, each with a valve flow cross-section. The valve flow cross-sections of the inlet openings of the several inlet valves form several valve flow cross-sections. In particular, the several valve flow cross-sections have a largest valve flow cross-section. It can also be provided that all valve flow cross-sections of the several valve flow cross-sections are the same size. In this case, the size of the largest valve flow cross-section corresponds to the size of a single valve flow cross-section. The channel has the largest duct flow cross-section. Advantageously, the largest channel flow cross-section is 5 times, in particular at most 3 times, in particular at most 1.5 times the largest valve flow cross-section. Thus, the liquid front can advance from one inlet opening to the next at a rapid speed. Thus, the time in which one inlet valve draws in air while the others or the other is already sucking in liquid is particularly short. Due to the small maximum channel flow cross-section, the negative pressure generated by the pistons in the still liquid-free region can be used particularly effectively to quickly supply the still dry inlet valves. This leads to the time in which the undesirable bubble formation can take place being short.

In particular, the largest channel flow cross-section is determined exclusively in the region between the first inlet valve and the last inlet valve. In particular, the region of the intake line upstream of the first inlet valve is not counted in the region in which the largest channel flow cross-section is determined.

The channel has a maximum width measured transversely, in particular in perpendicular to the direction of movement of the pistons. In particular, the maximum width is at most 5 times, in particular at most 3 times, in particular at most 1.5 times the largest valve flow cross-section. This also leads to the liquid travelling from the first inlet valve to the inlet valves located downstream of the first inlet valve in a particularly short time. Thus, the time window for bubble formation is small and bubble formation is suppressed as much as possible.

In an imaginary projection in the direction of the direction of movement of the pistons on a projection plane that is orientated in perpendicular to the direction of movement of the pistons, the channel has a channel area in the projection plane. In an imaginary projection in the direction of the direction of movement of the pistons on the projection plane, the inlet openings of all several inlet valves have a common total valve area in the projection plane. The total valve area is therefore composed of several individual areas that are allocated to the individual inlet openings of the several inlet valves. Expediently, the channel area is at most 15 times, in particular at most 12 times, the total valve area. Thus, the area of the volume in which liquid penetrates from the first inlet valve to the other inlet valves is particularly small, in particular in comparison to the prior art. Thus, the negative pressure generated by the dry pump pistons can be used particularly well in order to allow the liquid to penetrate quickly. Thus, the formation of bubbles is reduced.

The channel has a channel volume in the region from the first inlet valve to the end of the channel. Expediently, the quotient of the channel volume and the total valve surface area is smaller than 30 mm, in particular smaller than 25 mm, in particular smaller than 24 mm. Thus, the channel volume is particularly small. Thus, the negative pressure generated by the still dry pistons can be used particularly well in order to allow the liquid to penetrate quickly from the already wet first valve to the other valves.

The channel has a channel height measured in the direction of movement of the pistons. In particular, the channel height decreases in the direction of flow of the liquid. In particular, the channel height decreases continuously in the direction of flow of the liquid. In particular, the channel height decreases continuously in the direction of flow of the liquid starting from the first inlet valve to the last inlet valve. Thus, a sufficient negative pressure can also be generated by the pistons further downstream when the pistons further upstream are already supplied with liquid in order to allow the liquid to penetrate quickly to the still dry inlet valves. Thus, a uniform flow speed can be generated in the channel during regular operation when all inlet valves are supplied with liquid.

The liquid distribution device has a pipe section between the channel and the connection device. In particular, the pipe section has a pipe flow cross-section immediately adjacent to the channel.

The reservoir has a reservoir area in the region of the channel in an imaginary projection in the direction of the direction of movement of the pistons in a projection plane which is orientated in perpendicular to the direction of movement of the pistons. Advantageously, the reservoir area is from 10% to 50%, in particular from 20% to 30%, of the pipe flow cross-section.

### BRIEF DESCRIPTION OF THE DRAWINGS

An exemplary embodiment of the invention is explained in more detail below by means of the drawings.

FIG. 1 shows a perspective depiction of a cleaning device.

FIG. 2 shows a top view from above of the cleaning device from FIG. 1.

FIG. 3 shows a side view of the cleaning device from FIG. 1.

FIG. 4 shows a schematic sectional depiction of a cut-out along the sectional line IV-IV from FIG. 3.

FIG. 5 shows a schematic perspective sectional depiction of a cut-out along the sectional line VI-VI from FIG. 4.

FIG. 6 shows a schematic sectional depiction of a cut-out along the sectional line VII-VI from FIG. 4.

FIG. 7 shows a sectional depiction of a cut-out along the sectional line VII-VII from FIG. 4.

FIG. 8 shows a perspective depiction of the pump and the drive of the pump of the cleaning device from FIG. 1.

FIG. 9 shows a perspective depiction of the pump, the drive, and the hose reel of the pump from FIG. 1.

FIG. 10 shows a schematic perspective depiction of the cleaning device from FIG. 1 with partially opened housing outer wall for the purposes of the depiction and with partially cut-out depiction of the pump and a liquid distribution device allocated to the pump.

FIG. 11 shows a perspective depiction of the liquid distribution device from FIG. 10.

FIG. 12 shows a view in the direction of the direction of movement of the pistons of the pump on the liquid distribution device from FIG. 10.

FIG. 13 shows a perspective depiction of the liquid distribution device from FIG. 10 in a view of the side of the liquid distribution device facing towards the several inlet valves of the pump.

FIG. 14 shows a view in the direction of the direction of movement of the several pistons of the pump on the side of the liquid distribution device, which is facing towards the several inlet valves.

FIG. 15 shows a sectional depiction of the cut-out along the sectional line XV-XV from FIG. 12.

FIG. 16 shows a sectional depiction of the cut-out along the sectional line XVI-XVI from FIG. 15.

FIG. 17 shows a perspective depiction of a cut-out along the sectional line XVII-XVII from FIG. 12.

FIG. 18 shows the sectional depiction from FIG. 15, wherein, in addition to the liquid distribution device, a part of the pump and the inlet valves is also schematically depicted.

FIG. 19 shows a sectional depiction of a cut-out along the sectional line XIX-XIX from FIG. 18.

FIG. 20 shows a side view of the sectional plane from FIG. 17.

FIG. 21 shows a schematic perspective depiction of the volume of a channel, which is delimited by the liquid distribution device and extends from a first inlet valve to an end of the channel.

### DETAILED DESCRIPTION

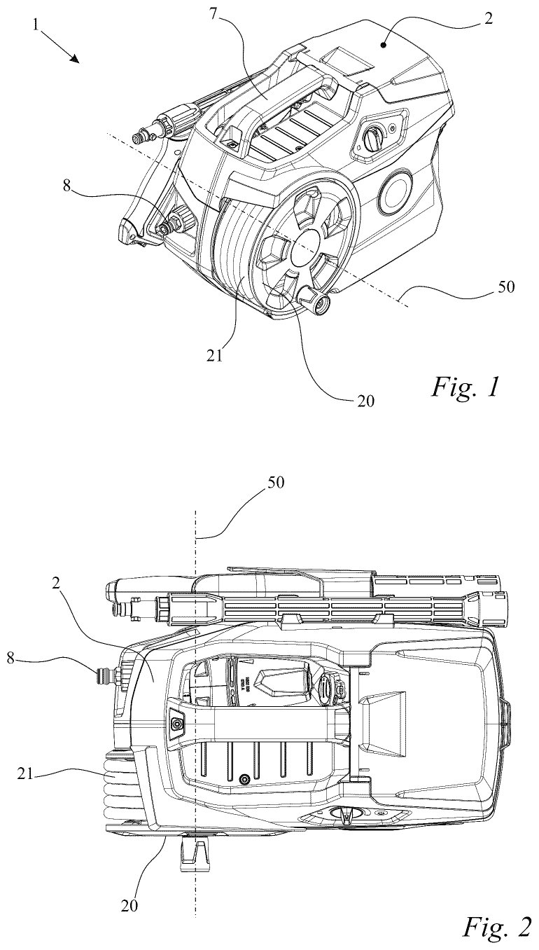

FIG. 1 shows a cleaning device 1. The cleaning device 1 is designed for cleaning objects with pressurized liquid. In the exemplary embodiment, the cleaning device 1 is portable. The cleaning device 1 has a handle 7. The cleaning device 1 can be carried by the handle 7. In intended operation, it is provided that the cleaning device 1 is switched off. In the exemplary embodiment, the cleaning device 1 is a pressure washer. In the exemplary embodiment, the cleaning device 1 is a battery-powered pressure washer. It may also be provided that the cleaning device 1 is portable in operation, in particular together with a pump 10 depicted in FIG. 4 as a unit. The pump 10 is a component of the cleaning device 1.

The cleaning device 1 has a housing 2 (FIG. 1). The housing 2 delimits the cleaning device 1 at least partially on the outside. The cleaning device 1 has a hose reel 20. As depicted in FIGS. 1 to 4, the hose reel 20 is mounted to be able to rotate around an axis of rotation 50. The cleaning device 1 comprises a reel hose 21. The reel hose 21 can be rolled onto and unrolled from the hose reel 20. The reel hose 21 can be wound onto and unwound from the hose reel 20.

The pump 10 is arranged in the housing 2, as depicted in FIG. 4, for example. In the exemplary embodiment, the pump 10 is a high-pressure pump. Liquid can be pressurized in the cleaning device 1 by means of the pump 10. By means of the pump 10, the liquid can be pressurized to a pressure of at least 10 bar, in particular at least 15 bar, in particular at least 30 bar, in particular at least 100 bar. In particular, the high-pressure pump 10 can be used to pressurize the liquid to a maximum of 600 bar, in particular to a maximum of 500 bar. The pump 10 comprises at least one piston 11. The at least one piston 11 is shown schematically in FIG. 4. The at least one piston 11 can be moved back and forth in a direction of movement 51 to generate pressure on the liquid. In the exemplary embodiment, the pump 10 comprises three pistons 11.

The pump 10 has a center axis 48 running in the direction of movement 51 of the piston 11 (or pistons 11). The center axis 48 is a central axis of the pump 10. In the exemplary embodiment, the pump 10 comprises several pistons 11. The center axis 48 runs centrally of the several pistons 11. The center axis 48 is the axis of symmetry with respect to the set of all the several pistons 11. In the exemplary embodiment, the several pistons 11 are arranged on an imaginary circular line as viewed in the direction of movement 51 of the pistons 11. The center axis 48 runs through the center of the circular line. In the exemplary embodiment, the center axis 48 is at the same distance from all pistons 11. This distance is measured perpendicularly, in particular radially to the direction of movement 51 of the piston 11 (or pistons 11). However, it can also be provided that the pistons 11 are arranged in a row, in particular on an imaginary straight line. The center axis 48 then runs through the straight line and divides the set of all pistons 11 along the straight line into two equal halves. In particular, the longitudinal direction of the pistons runs transversely, in particular perpendicularly to the straight line. The center axis 48 then lies in the middle of the total quantity of all pistons 11. Here, the center axis 48 can also run through one of the pistons 11.

In the exemplary embodiment, the pump 10 comprises a swash plate 12, which is depicted schematically in FIG. 4. The swash plate 12 is mounted to be able to rotate around a disc rotation axis 47. During operation of the cleaning device 1, the swash plate 12 drives the at least one piston 11 of the pump 10. The swash plate 12 rotates around the disc rotation axis 47. In doing so, the swash plate 12 presses the at least one piston 11 in the direction of the liquid. In particular, the liquid is here pressurized towards a piston chamber not depicted. The movement of the piston 11 in the direction of movement 51 towards the liquid reduces the volume of the piston chamber. During the movement of the at least one piston 11 towards the liquid, a return element not depicted, such as a spring, is tensioned. Due to the return force of the spring, the at least one piston 11 is then pushed away from the liquid again. The swash plate 12 then ensures that the at least one piston 11 moves in the opposite direction again. The swash plate 12 has an inclined surface for contact with the piston 11. The inclined surface runs at an angle to the disc rotation axis 47. The center axis 48 of the pump 10 runs coaxially to the disc rotation axis 47 of the swash plate 12. During operation of the cleaning device 1, liquid can be conveyed to the reel hose 21 by means of the pump 10. During operation, the pump 10 sucks in liquid.

The direction of movement 51 of the piston 11 runs in parallel to the center axis 48. The direction of movement 51 of the piston 11 runs in parallel to the disc rotation axis 47. The direction of movement 51 of the piston 11 runs transversely, in the exemplary embodiment perpendicularly to the axis of rotation 50 of the hose reel 21.

An outlet valve is allocated to each piston chamber. The liquid can escape from the respective piston chambers through the outlet valves and, in particular, flow in the direction of the reel hose 21. The outlet valve is a non-return valve. It prevents backflow from the reel hose 21 into the piston chamber.

As shown in FIG. 4, the high-pressure pump 10 comprises a base body 13. The pistons 11 are arranged in the base body 13. The pump 10 comprises the pistons 11. A piston chamber in which the liquid can be pressurized is allocated to each piston 11. An inlet valve 41, 42, 43 is allocated to each piston chamber. An outlet valve, not depicted, is allocated to each piston chamber. The inlet valve is a component of the pump 10. The outlet valve is a component of the pump 10. The piston chamber is a component of the pump 10. The inlet valve 41, 42, 43 is held in the base body 13. The outlet valve is held in the base body 13. The component that causes the back and forth movement of the pistons 11 in the direction of movement 51 is a component of the pump 10. In the exemplary embodiment, the swash plate 12 is a component of the pump 10. It can also be provided that the back and forth movement of the pistons 11 is caused by a crankshaft. In this case, the crankshaft is a component of the pump 10. The swash plate 12 includes a shaft 14. The pump 10 comprises a shaft housing 15. The shaft 15 is rotatably mounted in the shaft housing 15. The swash plate 12 can be rotated in relation to the shaft housing 15. If the piston 11 or pistons 11 is or are driven by a crankshaft for the back and forth movement in the direction of movement 51, the crankshaft is rotatably mounted in the shaft housing 15.

The cleaning device 1 comprises a drive 5. The drive 5 serves to drive the pump 10. The drive 5 is not a component of the pump 10. In the exemplary embodiment, the drive 5 is an electric motor. In particular, the drive 5 is a direct current motor. In particular, the drive 5 is a brushless direct current motor. The brushless direct current motor is also referred to as an EC motor.

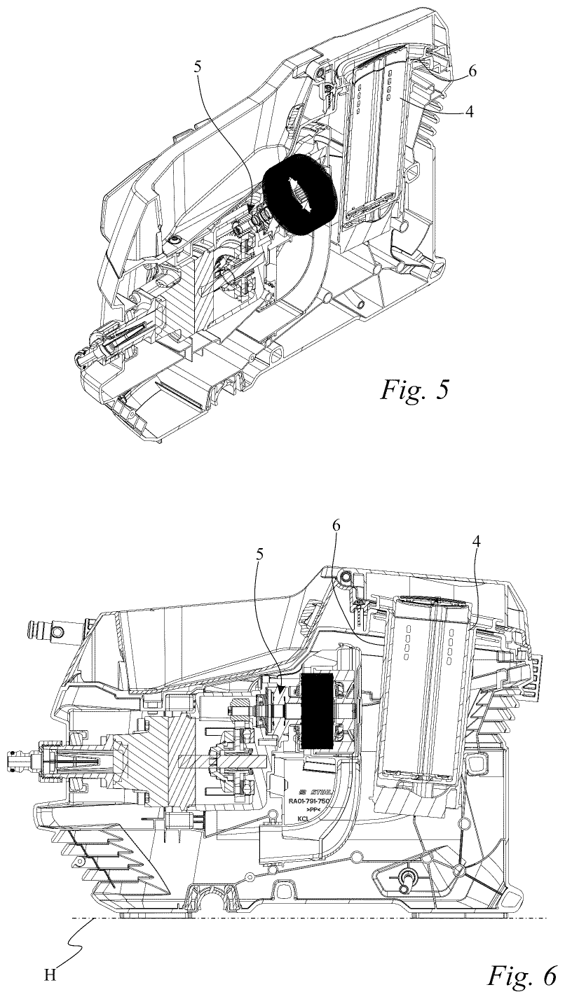

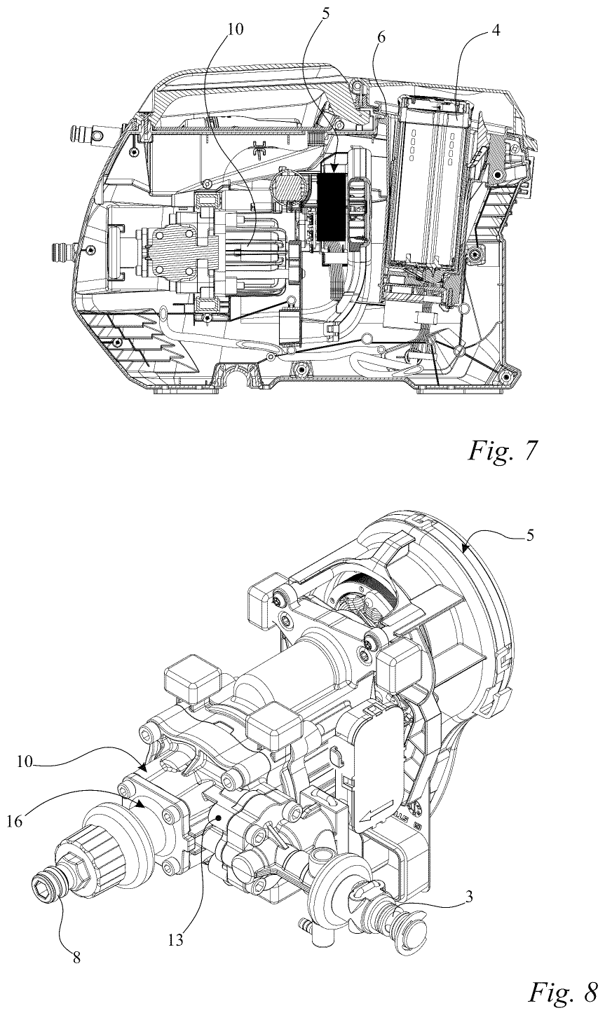

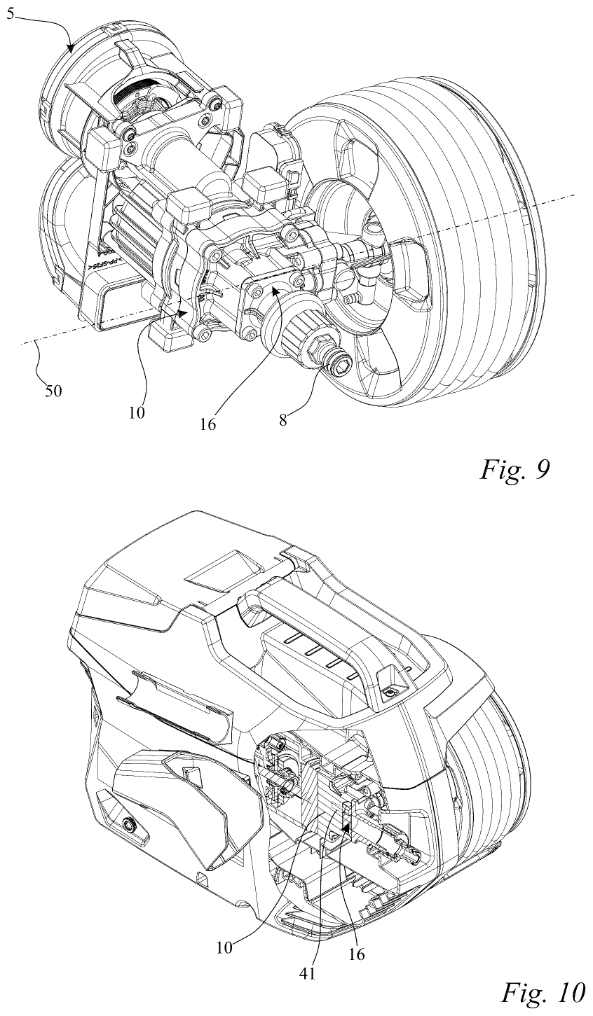

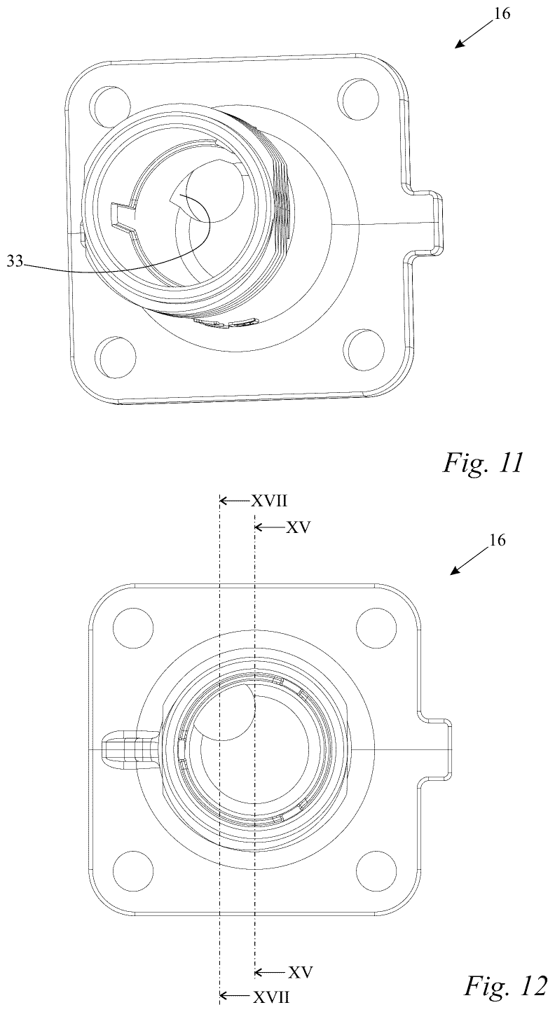

The high-pressure cleaning device 1 comprises a battery pack 4. The battery pack is depicted in FIGS. 4 to 7. The battery pack 4 serves for the energy supply of the drive 5 of the high-pressure pump 10. As also depicted in FIGS. 4 to 7, the high-pressure cleaning device 1 comprises a battery compartment 6. The battery compartment 6 serves to hold the battery pack 4. The battery pack 4 can be inserted into the battery compartment 6 through a compartment opening in the battery compartment 6. The compartment opening runs closed around the insertion direction of the battery pack 4. In the exemplary embodiment, the battery compartment 6 is arranged in the housing 2. In the exemplary embodiment, the battery pack 4 is arranged in the housing 2. With regard to the direction of movement 51, the battery compartment 6 and the pump 10 are arranged one behind the other. With regard to the direction of movement 5, the drive 5 is arranged between the battery compartment 6 and the pump 10. The drive 5 is arranged in the housing 2. The pump 10 is arranged in the housing 2. The pump 10, the drive 5 for the pump 10 and the battery compartment 6 are arranged one behind the other with regard to the direction of the center axis 48, in particular with regard to the direction of movement 51.

The cleaning device 1 comprises a connection device 8. The connection device 8 serves to connect a source line not depicted. The source line can be a hose, for example. The source line serves to feed liquid into the cleaning device 1. The source line can, for example, feed liquid from an external liquid source such as a body of water or a container, for example. The liquid is also referred to as cleaning liquid. The liquid is typically water. The connection device 8 can have a coupling. The coupling can interact with a counter-coupling of the source line when the source line is connected to the connection device 8. The source line for supplying the liquid can be plugged onto the coupling of the connection device by means of a suitable counter line. However, it can also be provided that the source line for supplying the liquid is fixed to the connection device 8 by means of a clamp or similar.

A liquid distribution device 16 is arranged between the connection device 8 and the pump 10. The liquid distribution device 16 serves to feed the liquid from the connection device 8 to the several inlet valves 41, 42, 43. In the exemplary embodiment, the connection device 8 is fixed to the liquid distribution device 16 by means of a screw connection. The connection device 8 is screwed onto the liquid distribution device 16. The liquid distribution device 16 serves to distribute the liquid to the several inlet valves 41, 42, 43. The connection device 8 is a common inlet of liquid for all inlet valves 41, 42, 43. The connection device 8 extends along the direction of movement 51. The connection device 8 protrudes in the direction of movement 51 in the direction away from the base body 13, in particular in the direction away from the liquid distribution device 16 beyond the liquid distribution device 16.

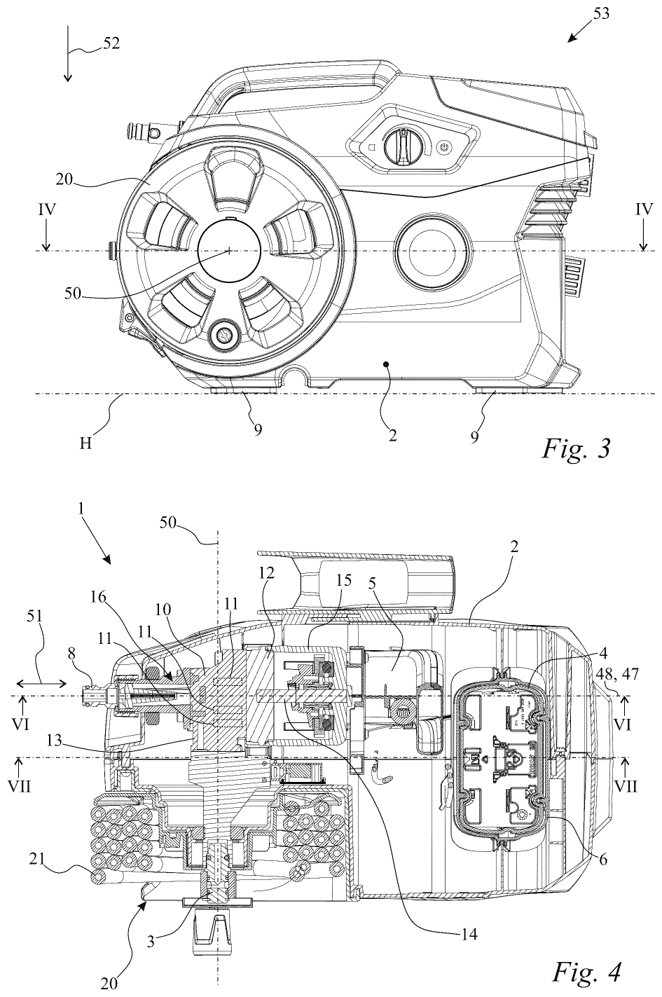

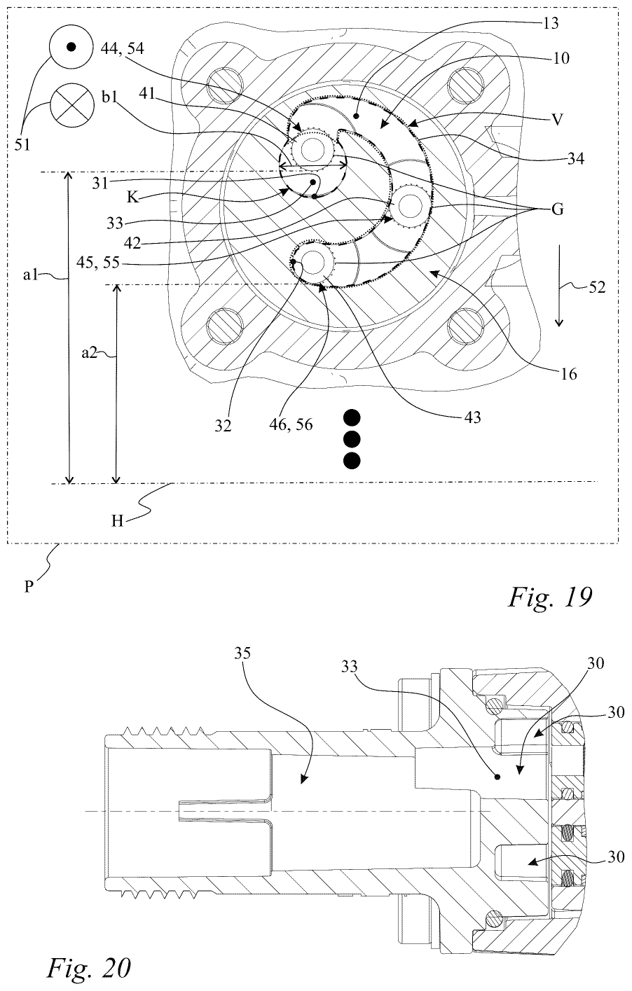

The liquid enters the cleaning device 1 through the connection device 8. The liquid is sucked in by the pump 10. Starting from the connection device 8, the liquid flows through the liquid distribution device 16 to the inlet valves 41, 42, 43. The liquid distribution device 16 is designed in such a way that it feeds the liquid to the several inlet valves 41, 42, 43 in a fixed predetermined sequence, independent of the orientation of the cleaning device 1 in relation to the direction 52 of gravity. The direction 52 of gravity is shown, for example, in FIGS. 3 and 19. The orientation of the cleaning device 1 in relation to the direction 52 of gravity can be determined, for example, by means of the orientation of the direction of movement 51 of the pistons 11 in relation to the direction 52 of gravity. The liquid distribution device 16 is designed in such a way that it feeds the liquid to the several inlet valves 41, 42, 43 in a fixed predetermined sequence independent of the orientation of the direction of movement 51 of the pistons 11 in relation to the direction 52 of gravity.

In particular, the liquid distribution device 16 is designed in such a way that it feeds the liquid to the several inlet valves 41, 42, 43 in a fixed predetermined sequence independent of the orientation of the pump 10 in relation to the direction 52 of gravity. Accordingly, independent of the orientation of the cleaning device 1, in particular the orientation of the pump 10, in particular the direction of movement 51, the first inlet valve 41, then the second inlet valve 42 and only then the last inlet valve 43 are supplied with liquid during the initial suction of the liquid by the connection device 8. The liquid distribution device 16 is designed in particular in such a way that it supplies the liquid to the several inlet valves 41, 42, 43 one after the other in a fixed predetermined sequence, independent of the orientation of the cleaning device 1, in particular the pump 10, in relation to the direction 52 of the gravitational force. In other words, one inlet valve after the other is supplied with liquid. The liquid first flows past the first inlet valve 41, or towards the first inlet valve 41, and only then towards the second inlet valve 42. Analogously, the liquid first flows towards the second inlet valve 42, or past the second inlet valve 42, and only then towards the last inlet valve 53.

When sucking in liquid through the source line, the air must first be sucked out of the source line. Only then does liquid enter the cleaning device 1 and reach the inlet valves 41, 42, 43. During this process, the liquid first passes the first inlet valve 41, then the second inlet valve 42 and finally the last inlet valve 43 until the air has been sucked out of the region between the pump 10 and the source. When the air is removed from the region in front of the pump 10, the liquid front passes the inlet valves 41, 42, 43 in a fixed predetermined sequence one after the other.

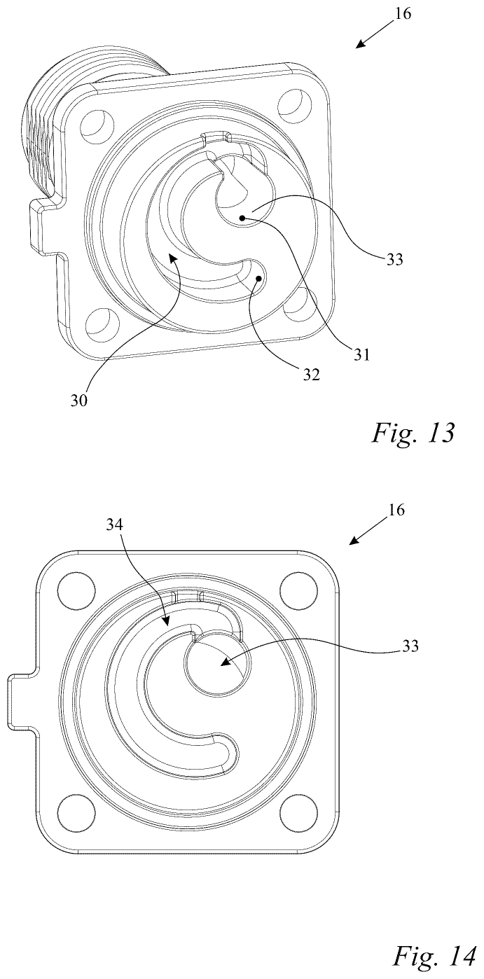

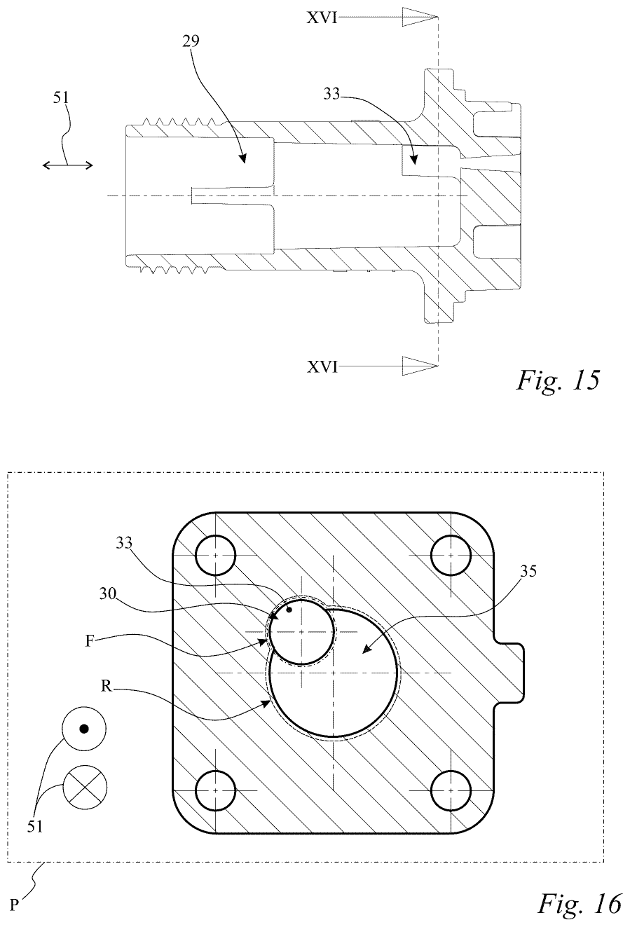

The liquid distribution device 16 comprises a channel 30 depicted in FIG. 13. The channel 30 has a beginning 31 and an end 32. The end 32 of the channel 30 is arranged downstream of the beginning 31 of the channel 30. The channel 30 is a groove-shaped recess in an end face of the liquid distribution device 16. This end face faces towards the pump 10. As depicted in FIG. 19, the channel 30 is covered, in particular closed, on its side facing towards the pump 10 by the pump 10, in particular by the base body 13 of the pump 10. The pump 10 forms an inner wall of the channel 30. On the other sides, the channel 30 is bordered by the liquid distribution device 16. As can be seen in FIG. 19, the first inlet valve 41 of the several inlet valves 41, 42, 43 is arranged at the beginning 31 of the channel 30. The last inlet valve 43 of the several inlet valves 41, 42, 43 is arranged at the end 32 of the channel 30. In the exemplary embodiment, the channel 30 is designed in such a way that the liquid can only flow along one path from the beginning 31 to the end 32 of the channel 30.

As depicted in FIG. 3, the cleaning device can be set down on a horizontal plane H in a set-down orientation 53 provided for this purpose. The horizontal plane H extends horizontally. The cleaning device 1 advantageously has at least one stand 9. In the exemplary embodiment, two stands 9 are provided. In the set-down orientation 53, the cleaning device 1 stands on the feet 9. However, it can also be provided that the cleaning device 1 is supported only by its housing 2 on the horizontal plane H. In the exemplary embodiment, the axis of rotation 50 of the hose reel 20 runs in parallel to the horizontal plane H when the cleaning device 1 is parked in the set-down orientation 53 provided for this purpose on the horizontal plane H. When the cleaning device 1 is parked in the set-down orientation 53 provided for this purpose on the horizontal plane, the center axis 48 depicted in FIG. 4 runs in parallel to the horizontal plane 48. When the cleaning device 1 is parked on the horizontal plane H in the set-down orientation 53 provided for this purpose, the disc rotation axis 47 runs in parallel to the horizontal plane H.

The horizontal plane H is also shown in FIG. 19. Only a section of the cleaning device 1 is depicted here, in which the channel 30 and the liquid distribution device 16 can be seen. The horizontal plane H is drawn exaggeratedly close to the liquid distribution device 16 for better visibility. As indicated by the three vertically arranged dots in FIG. 19, the distance between the horizontal plane H and the liquid distribution device 16 is in reality greater.

In FIG. 19, the cleaning device 1 or the liquid distribution device 16 is depicted in the set-down orientation 53. The cleaning device 1 is parked on the horizontal plane H. The channel 30 is designed in such a way that the first inlet valve 41 has the greatest distance a1 of all the several inlet valves 41, 42, 43 from the horizontal plane H in the set-down orientation 53. In particular, the channel 30 is designed in such a way that the last inlet valve 43 in the set-down orientation 53 has the smallest distance a2 of all several inlet valves 41, 42, 43 from the horizontal plane H. In the exemplary embodiment, the largest distance a1 is greater than the smallest distance a2. The liquid flows from the first inlet valve 41 to the last inlet valve 43 under the effect of gravity when the cleaning device 1 is parked in the set-down orientation 53 on the horizontal plane H.

The channel 30 is substantially helical. The beginning 31 of the channel 30 is arranged closer to the center axis 48 than the end 32 of the channel 30.

As depicted in FIG. 19, the several inlet valves 41, 42, 43 are arranged in the base body 13 of the pump 10. The several inlet valves 41, 42, 43 are arranged in the pump 10 in such a way that liquid can be fed to them from the channel 30 through an outer surface of the pump 10. The outer surface of the pump 10, in particular the outer surface of the base body 13 of the pump 10, forms an inner side of the channel 30. The outer surface of the pump 10 at least partially delimits the channel 30. Openings are provided in the outer surface of the pump 10 through which the liquid can flow to the inlet valves 41, 42, 43.

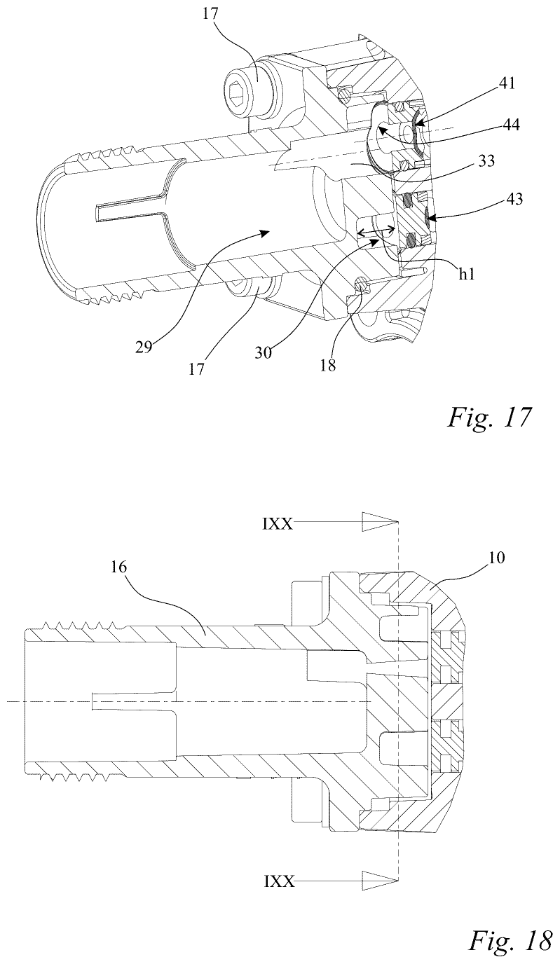

In order to cover the channel 30 in the direction of movement 51 of the pistons 11 in the direction from the liquid distribution device 16 to the pump 10, in particular to close it, the liquid distribution device 16 is pressed in this direction against the pump 10, in particular against the base body 13, in particular against the surface of the pump 10, in particular against the base body 13. In the exemplary embodiment, the screws 17 depicted in FIG. 17 are provided for this purpose. However, any other type of fastening means can also be used. A seal 18 is provided between the pump 10 and the liquid distribution device 16. In the exemplary embodiment, the seal 18 is a sealing ring, in particular an O-sealing ring.

The liquid enters the pump 10 from the channel 30 in the direction of movement 51 of the pistons 11. The liquid enters the pump 10 directly from the channel 30.

As depicted in FIG. 19, the channel 30 comprises a reservoir 33. The reservoir 33 is open in the direction of movement 51 of the pistons 11 in the direction away from the pump 10. There is no side wall of the reservoir in this direction. In the direction of movement 51 of the pistons 11 in the direction towards the pump 10, the reservoir 33 is bordered by the pump 10, in particular by the base body 13 of the pump 10, in particular by the first inlet valve 41. In the transverse direction, in particular perpendicular to the direction of movement 51 of the pistons 11, the reservoir 33 is delimited by the liquid distribution device 16, in particular by a side wall of the channel 30. In the direction of gravity 52, the reservoir 33 is delimited by the liquid distribution device 16, in particular by a side wall of the channel 30. The reservoir 33 is a type of overflow basin. The reservoir 33 is arranged at the beginning 31 of the channel 30. The reservoir 33 and the channel 30 are designed in such a way that, in the set-down orientation 53 on the horizontal plane H, only the first inlet valve 41 can be supplied with liquid from the channel 30 as long as the reservoir 33 has not overflowed. The channel 30 has a portion 34. The portion 34 of the channel 30 is arranged downstream of the reservoir 33. The portion 34 of the channel downstream of the reservoir 33 is directly adjacent to the reservoir 33. The portion 34 of the channel 30 downstream of the reservoir 33 is only supplied with liquid after the reservoir has overflowed when the cleaning report 1 is in the set-down orientation 53 on the horizontal plane H. The inlet valves 42, 43 downstream of the first inlet valve 41 are arranged in the set-down orientation 53 on the horizontal plane H below the overflow level of the reservoir 33.

As depicted in FIG. 19, the several inlet valves 41, 42, 43 each have an inlet opening 44, 45, 46 facing towards the channel 30. The first inlet valve 41 has a first inlet opening 44. The second inlet valve 42 has a second inlet opening 45. The last inlet valve 43 has a last inlet opening 46. Each inlet opening 44, 45, 46 has a valve flow cross-section 54, 55, 56. The first inlet opening 44 has the first valve flow cross-section 54. The second inlet opening 45 has the second valve flow cross-section 55. The last inlet opening 46 has the last valve flow cross-section 56. Several valve flow cross-sections 54, 55, 56 are formed by the valve flow cross-sections 54, 55, 56. The several valve flow cross-sections 54, 55, 56 have a largest valve flow cross-section 54, 55, 56. In the exemplary embodiment, all valve flow cross-sections 54, 55, 56 are the same size. The largest valve flow cross-section thus corresponds to the valve flow cross-section of the inlet opening of a single inlet valve. The valve flow cross-sections 54, 55, 56 are orientated in a transverse direction, in the exemplary embodiment in a direction perpendicular to the direction of movement 51 of the pistons 11.

The channel 30 has the largest channel flow cross-section. In the exemplary embodiment, the largest channel flow cross-section extends in the direction of movement 51 and radially thereto. It may be provided that the largest channel flow cross-section is ascertained exclusively in the portion 34 of the channel 30. It may also be provided that the largest channel flow cross-section is ascertained exclusively in the region of the channel 30 between the first inlet valve 41 and the end 32 of the channel 30. In the exemplary embodiment, the largest channel flow cross-section is ascertained between the beginning 31 of the channel 30 and the end 32 of the channel 30.

The largest channel flow cross-section is at most 5 times, in particular at most 3 times, in the exemplary embodiment at most 1.5 times, the largest valve flow cross-section 54, 55, 56. In the exemplary embodiment, the valve flow cross-section 54, 55, 56 is the area of the inlet opening 44, 45, 46 of the inlet valve 41, 42, 43 measured in the direction perpendicular to the direction of movement 51. In particular, this is a solid surface in which no hollow surface is provided within the outer contour of the surface. In other words, the area covered by the valve member is not taken into consideration when determining the valve flow cross-section. However, it can also be provided that the valve flow cross-section is a true flow cross-section.

As depicted in FIG. 19, the channel 30 has a maximum width b1 measured transversely, in the exemplary embodiment perpendicular to the direction of movement 51. It may be provided that the maximum width b1 is determined exclusively in the region 34 of the channel 30. It can also be provided that the maximum width b1 is determined exclusively in the region of the channel 30 between the first inlet valve 41 and the end 32 of the channel 30. In the exemplary embodiment, the maximum width b1 is determined between the beginning 31 and the end 32 of the channel 30. The maximum width b1 extends in the direction perpendicular to the direction of flow of the liquid. The maximum width b1 extends in the direction radial to the direction of movement 51 of the pistons 11. The maximum width b1 is at most 5 times, in particular at most 3 times, in the exemplary embodiment at most 1.5 times the largest valve flow cross-section 54, 55, 56.

The channel 30 has a channel area K in an imaginary projection in the direction of movement 51 of the pistons 11 in a projection plane P. The projection plane P extends perpendicularly to the direction of movement 51 of the pistons 11. The projection plane P extends perpendicularly to the direction of movement 51 of the pistons 11. The channel area K extends in the projection plane P. In an imaginary projection in the direction of the direction of movement 51 of the pistons 11, the inlet openings 44, 45, 46 of all several inlet valves 41, 42, 43 have a common total valve area G in the projection plane P. In the exemplary embodiment, the total valve area G corresponds to the sum of the valve flow cross-sections 54, 55, 56. The channel area K is at most 15 times, in the exemplary embodiment at most 12 times, the total valve area G.

The channel 30 has a channel volume V in the region from the first inlet valve 41 to the end 32 of the channel 30. The channel volume V is depicted in FIG. 21. The quotient of channel volume V and total valve area G is less than 30 mm, in particular less than 25 mm, in the exemplary embodiment less than 24 mm. Expressed in formulas, this means: V/G<30 mm, in particular V/G<25 mm, in the exemplary embodiment V/G<24 mm.

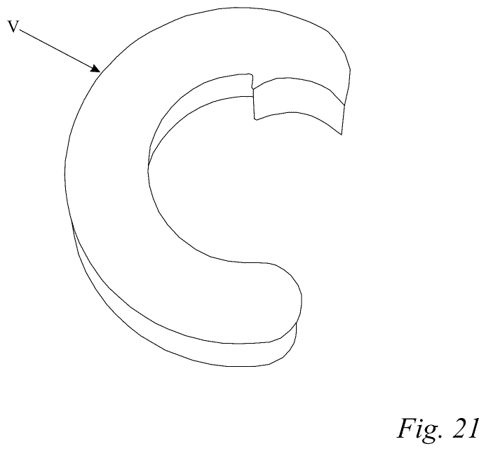

As depicted in FIGS. 20 and 16, the liquid distribution device 16 has a pipe section 35 between the channel 30 and the connection device 8. The pipe section 35 is directly adjacent to the channel 30. The pipe section 35 is directly adjacent to the reservoir 33 of the channel 30. The pipe section 35 has a pipe flow cross-section R directly adjacent to the channel 30. The pipe flow cross-section R extends perpendicularly to the direction of movement 51 of the pistons 11.

In an imaginary projection in the direction of movement 51 of the pistons 11 into the projection plane P, which runs perpendicularly to the direction of movement 51 of the pistons 11, the reservoir 33 of the channel 30 has a reservoir area F (FIG. 16). The reservoir area is from 10% to 50%, in the exemplary embodiment from 20% to 30% of the pipe flow cross section R.

As depicted in FIG. 17, the channel 30 has a channel height h1 measured in the direction of movement 51 of the pistons 11. The channel height h1 extends between the pump 10 and a bottom of the channel 30, which is formed by the liquid distribution device 16. The height h1 decreases in the flow direction of the liquid starting from the first inlet valve 41 to the end 32 of the channel 30, in the exemplary embodiment it decreases continuously. In the exemplary embodiment, the width of the channel 30 is constant in the region between the first inlet valve 41 and the end 32 of the channel 30. However, it can also be provided that the width of the channel decreases in the flow direction, in particular decreases continuously.

What is claimed is:

1. A cleaning device (1) for pressurizing and spraying out a liquid, the cleaning device (1) comprising:
a pump (10), the pump comprising
pistons (11),
piston chambers, a respective piston chamber being coupled to each of the pistons (11), wherein the liquid is pressurized in the respective piston chamber by a respective one of the pistons (11), and
inlet valves (41, 42, 43), a respective inlet valve (41, 42, 43) being coupled to each of the piston chambers;
a connection device (8) for connecting a source line for supplying the liquid; and
a liquid distribution device (16) for supplying the liquid from the connection device (8) to the inlet valves (41, 42, 43) arranged between the connection device (8) and the pump (10),
wherein the liquid distribution device (16) is configured to supply the liquid to the inlet valves (41, 42, 43) in a fixed predetermined sequence independently of an orientation of the cleaning device (1) in relation to a direction (52) of gravity.

2. The cleaning device according to claim 1,
wherein the liquid distribution device (16) is configured to supply the liquid to the inlet valves (41, 42, 43) one after another in the fixed predetermined sequence, independent of the orientation of the cleaning device (1) in relation to the direction (52) of gravity.

3. The cleaning device according to claim 1,
wherein the liquid distribution device (16) comprises a channel (30) with a beginning (31) and an end (32),
wherein a first inlet valve (41) of the inlet valves (41, 42, 43) is arranged at the beginning (31) of the channel (30), and
a last inlet valve (43) of the inlet valves (41, 42, 43) is arranged at the end (32) of the channel (30).

4. The cleaning device according to claim 3,
wherein the cleaning device (1) is configured to be set-down on a horizontal plane (H) in a set-down orientation (53), and
wherein the channel (30) is designed such that the first inlet valve (41) in the set-down orientation (53) has a greatest distance (a1) from the horizontal plane (H) of all inlet valves (41, 42, 43).

5. The cleaning device according to claim 4,
wherein a reservoir (33) is formed at the beginning (31) of the channel (30), and
wherein the channel (30) is formed such that in the set-down orientation (53) only the first inlet valve (41) is supplied with liquid from the channel (30) as long as the reservoir (33) has not overflowed and a section (34) of the channel (30) downstream of the reservoir (33) is supplied with liquid by an overflow of the reservoir (33).

6. The cleaning device according to claim 3,
wherein the inlet valves (41, 42, 43) each have an inlet opening (44, 45, 46) facing towards the channel (30), each with a valve flow cross-section (54, 55, 56), whereby valve flow cross-sections (54, 55, 56) are formed,
wherein the valve flow cross-sections (54, 55, 56) have a largest valve flow cross-section (54, 55, 56),
wherein the channel (30) has a largest channel flow cross-section, and
wherein the largest channel flow cross-section is at most five times the largest valve flow cross-section (54, 55, 56).

7. The cleaning device according to claim 6,
wherein the channel (30) has a maximum width (b1) measured transversely to a direction of movement (51) of the pistons (11), and
wherein the maximum width (b1) is at most five times the largest valve flow cross-section (54, 55, 56).

8. The cleaning device according to claim 6,
wherein, in an imaginary projection towards a direction of movement (51) of the pistons (11) in a projection plane (P) perpendicular to the direction of movement (51) of the pistons (11), the channel (30) has a channel area (K) on the projection plane (P),
wherein the inlet openings (44, 45, 46) of all inlet valves (41, 42, 43) have a total valve area (G) in the projection plane (P), and
wherein the channel area (K) is at most 15 times the total valve area (G).

9. The cleaning device according to claim 8,
wherein the channel (30) has a channel volume (V) in a region from the first inlet valve (41) to the end (32), and
wherein a quotient of the channel volume (V) and the total valve area (G) is less than 30 mm.

10. The cleaning device according to claim 3,
wherein the channel (30) has a channel height (h1) measured in the direction of movement (51) of the pistons (11), and
wherein the channel height (h1) decreases in a flow direction of the liquid.

11. The cleaning device according to claim 1,
wherein the cleaning device is portable.

12. The cleaning device according to claim 1,
wherein the liquid distribution device (16) is configured to supply the liquid to the inlet valves (41, 42, 43) in the fixed predetermined sequence independent of an orientation of the pump (10) in relation to the direction (52) of gravity.

13. The cleaning device according to claim 3,
wherein the channel (30) is designed such that the liquid can only flow in one path from the beginning (31) to the end (32) of the channel (30).

14. The cleaning device according to claim 4,
wherein the channel (30) is designed such that the last inlet valve (43) in the set-down orientation (53) has a smallest distance (a2) of all inlet valves (41, 42, 43) to the horizontal plane (H).
